(19) United States
(12) Patent Application Publication
(10) Pub. No.: US 2007/0164870 A1
(43) Pub. Date: Jul. 19, 2007

(54) Signaling device for a dental patient

(76) Inventor: Roberto Squillario, Flero (IT)

Correspondence Address: SHOEMAKER AND MATTARE, LTD, 10 POST OFFICE ROAD - SUITE 110, SILVER SPRING, MD, 20910, US

(21) Appl. No.: 10/597,011

(22) PCT Filed: Jan. 21, 2004
(86) PCT No.: PCT/IT04/00009

§ 371 Date: Jul. 6, 2006

(51) Int. Cl. G08B 23/00; G08B 13/00

(52) U.S. Cl. 340/573.1; 340/574

(57) ABSTRACT

A warning device (1) associable to a dental seat is adapted for warning an operator (2) of a patient's request. The device comprises a warning box (12) provided with one or more switches (14), the pressure of which lights a portion (14) provided with an icon representing the patient's request on a display (22), visible to the patient. Upon the patient's confirmation, for example automatically after a predetermined time interval, sound emission means emit, in a predetermined language, a signal that can be interpreted by the operator or a voice message corresponding to the patient's request. The device allows communicating the request to the operator without distracting or interrupting him/her and without making sudden movements, besides without having the need of speaking, which is often denied during dental operations.

The present invention relates to a warning device associable to a dental seat, adapted for warning the operator, for example a dentist, of a patient's request.

As known, during a dental session for even simple operations, for example removing dental caries or taking impressions of a tooth or the like, the patient sitting on the seat chair may have the need to speaking to the operator.

For example, the patient may need to indicate that he/she is feeling pain, or that he/she needs to rinse his/her mouth.

Generally, in these cases the patient is instructed to raise his/her hand.

At that point the operator stops his/her activity and tries to understand what the patient's need is, but often he/she cannot talk.

Sometimes this situation can cause problems to the patient, especially when he/she cannot indicate his/her needs to the operator.

The need of providing the dental seat with a warning device adapted for warning the operator of a patient's request is therefore strongly felt.

Object of the present invention is that of meeting the above requirements, obviating the disadvantages mentioned with reference to the prior art.

This object is achieved by a warning device according to claim 1. The depending claims describe embodiment variants.

The features and advantages of the present invention will appear more clearly from the following description, made by way of a non-limiting example with reference to the attached drawings, wherein:

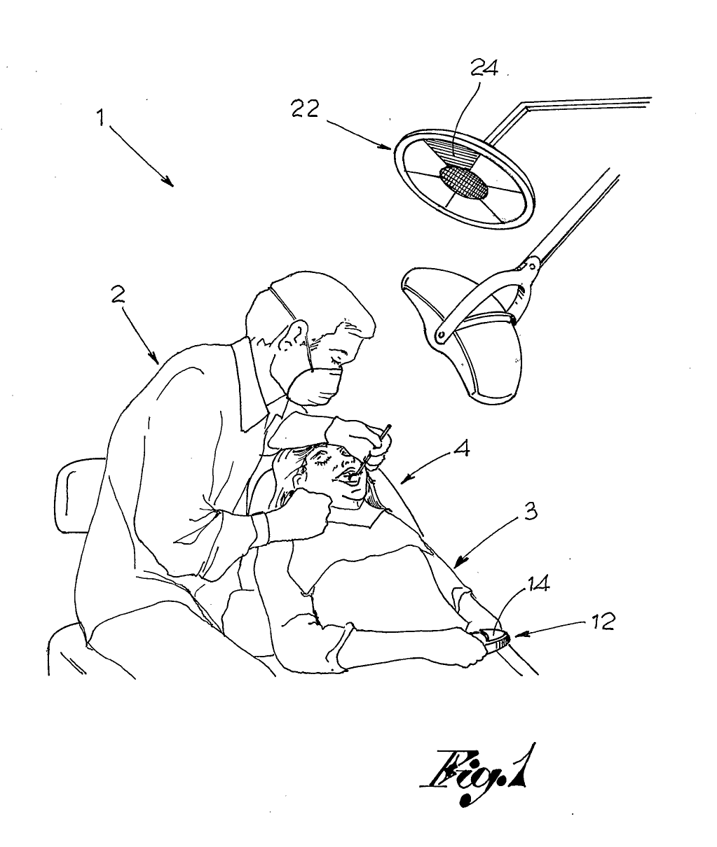

FIG. 1 shows a setting for the warning device;

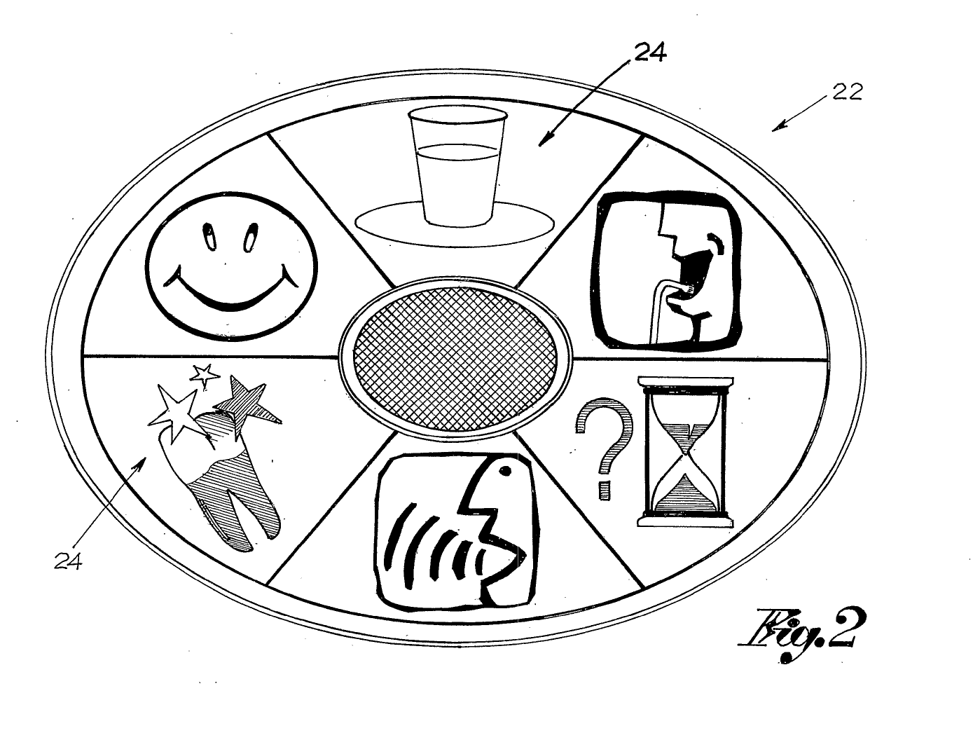

FIG. 2 shows a front plan view of a display of the warning device;

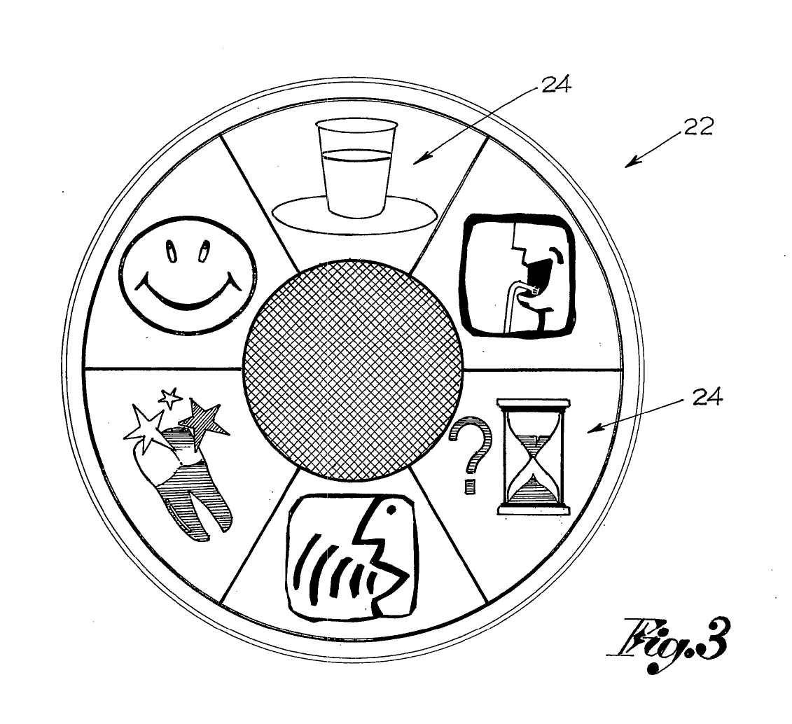

FIG. 3 shows a front plan view of a display of the warning device, according to an embodiment variant;

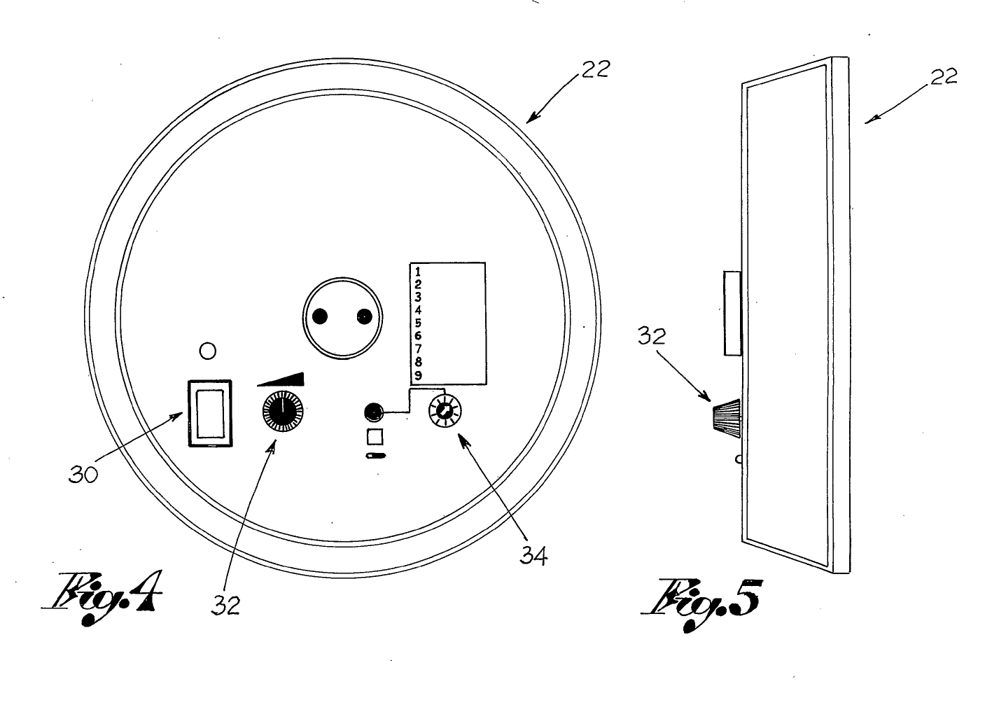

FIGS. 4 and 5 respectively show a rear plan view and a side view of the display of FIG. 3.

With reference to the attached figures, reference numeral 1 globally indicates a dental seat, adapted for carrying out an operation by an operator 2, for example a dentist, on a patient 3.

The seat 1 comprises a chair 4, generally reclining, adapted for the patient's sitting and, by reclining, adapted for making the patient take a lying posture for the operator's operation.

The seat 1 further comprises operating means adapted for the operator's intervention on the patient.

For example, said operating means comprise a plurality of connections for the operating connection of a drill, a water sprinkler, a water and disinfectant sprinkler, and the like.

Moreover, in a preferred embodiment, said seat comprises water dispensing means, adapted for dispensing water from a nozzle for filling a glass.

The seat 1 can be associated to a warning device adapted for warning the operator of a patient's request.

The device comprises handling means, adapted for being handled by the patient for sending a request signal.

In a preferred embodiment, said handling means comprise a warning box 12, preferably with oval or circular shape, adapted for being gripped by the patient.

The warning box 12 comprises at least one switch 14 for sending the request signal.

In an embodiment variant, said warning box 12 comprises a plurality of switches 14. Each switch 14 exhibits, for example on the visible surface, a representation of the patient's request.

Moreover, said warning device comprises reception means, in operating connection with said handling means, adapted for receiving the request signal.

Preferably, said reception means are connected to said handling means by radio waves carrying the request signal.

According to a preferred embodiment, said handling means and said reception means comprise means for adjusting the transmission and reception frequency of the reception signal, for example for changing said frequency according to the regulations of the country where said device is used, or for preventing interferences with other equipment used in the place where the device is installed.

Moreover, said device comprises interpreting means, in operating connection with said reception means, and adapted for emitting a signal that can be interpreted by the operator.

Preferably, said interpreting means comprise an electronic control unit adapted for acquiring the signal received by the reception means and for interpreting said signal, associating a patient's request.

The electronic control unit is operatively connected to a display 22 having at least one illuminable portion 24.

According to a preferred embodiment, said seat comprises support means for said interpreting means, said support means being adapted for positioning the interpreting means in a position visible to the patient.

For example, said support means comprise a support frame 24 of display 22, with adjustable height, so as to set the display in a position visible by the patient. Moreover, in an embodiment, said support means comprise means for adjusting the display inclination, adapted for tilting said display for an easier view by the patient.

Preferably, said display 22 comprises a plurality of illuminable portions, each portion being distinguishable from the other.

For example, said portions are distinguishable from one another by their different colour or by their different position on said display.

According to a preferred embodiment, each of said illuminable portions exhibits an icon representing the specific request made by the patient.

For example, said icons represent a glass to be filled to indicate a request for water; a smiling face to indicate that there are no problems; an inflamed tooth to indicate that the patient is feeling pain; a speaking figure to indicate that the patient would like to speak; a sandglass to indicate that the patient would like to know how long the operation is going to take; a figure with an aspirator to indicate that the patient would like his/her saliva to be aspirated.

Preferably, moreover, said interpreting means comprise sound emission means adapted for emitting a sound signal based on the signal received and corresponding to the patient's request.

For example, said sound signal comprises a voice message adapted for being understood by the operator.

Preferably, said sound emission means comprise a plurality of integrated circuits, for example voice synthesisers with integrated memory. In a variant of embodiment, said voice emission means comprise a properly programmed DSP (Digital Signal Processing).

Moreover, according to a preferred embodiment, the seat 1 comprises control means operatively connected to said interpreting means.

For example, said control means comprise a master switch 30 for starting or stopping the device.

Preferably, said control means comprise means for adjusting the volume 32 of the sound emission means.

Preferably, moreover, said control means comprise language setting means 34 adapted for selecting a language in which said sound emission means of the patient's request emit said request or said voice message.

For example, said language setting means comprise a microprocessor operatively connected to a device for reading and storing the data which, interpreted by said interpreting means, generate said sound signals.

In a variant of embodiment, said language setting means comprise a voice recording device and a device for reading and storing data adapted for recording the operator's voice and converting it into data which, interpreted by said interpreting means, generate said sound signals.

According to a preferred embodiment, said control means are integrated to the display and accessible for being actuated, for example, from its back area, or from the area opposed to that with said distinguishable portions.

In a preferred embodiment, said device comprises removable protection means adapted for covering said handling means.

For example, said protection means comprise a transparent cover adapted for being positioned on the warning box, when said box must be gripped by a patient, and then removed and replaced with another cover, when it must be prepared for another patient.

For example, said protection means comprise a bag, preferably transparent, and flexible, adapted for containing the warning box.

In the normal use of the device, during the operator's intervention the patient holds the warning box in his/her hand.

Display 22, supported by the support frame, is generally placed in front of the patient, so that portions 24 can be seen by him/her.

Advantageously, the support frame 24 keeps the display raised so that it can be seen by the patient when he/she is lying on the reclined chair 4.

During the intervention of operator 2, when the patient has to make a request, he/she presses switch 14 on the warning box 12.

According to the embodiment, the patient can press a single switch multiple times, until portion 24 corresponding to the request to be made lights up on display 22.

Pressing another switch, called confirmation switch, or waiting for a few seconds activate sound emission means that emit a sound signal or a voice message, for example a pre-recorded voice, corresponding to the patient's request.

In a preferred embodiment, keeping switch 14 pressed for a predetermined time, the sound emission means emit said signal or said voice message.

Said message is emitted in the language selected by said language setting means.

If the language desired by the patient or by the operator is not comprised among those in which said sound signals are stored, the operator, for example during the installation of the warning device, can store voice messages corresponding to the display icons in the desired language, using said voice recording device.

At the end of the operations, the operator can remove the cover from the warning box and replace it with a new cover or replace the bag wherein said box was contained.

Unusually, the warning device according to the invention is adapted for communicating a precise patient's request to the operator, without the need for the operator of interrupting the operation, or for example, removing some accessories from the patient's mouth for him/her to tell his/her request.

Advantageously, moreover, said request is communicated without the need for the patient of trying to make sudden movements that may interfere with the operator's intervention.

According to an even further advantageous aspect, the warning box provided with a single switch allows simplifying the indication of the request on the display, by sequentially selecting the request.

Advantageously, moreover, the device prevents the patient from touching accessories held or actuated by other patients, thereby avoiding for example the transmission of infections and giving a sensation of hygiene.

It is clear that a man skilled in the art will be able to make several changes to the device described above.

For example, according to a variant of embodiment, the handling means exhibit a single switch that controls a stop signal for the operator, by simply lighting a portion of the display, for example red coloured.

According to a further variant of embodiment, the handling means comprise a lever that controls the lighting of a determined illuminable portion of the display.

According to a further variant, the handling means are integrated in the chair.

According to an even further variant, the display is placed on the wall or at a certain height, so as to be visible by the patient, by means adapted for keeping it hung, to a frame or to the roof.

According to a further variant of embodiment, the handling means are connected to the reception means by a cable.

It is clear that these variants are to be regarded as comprised within the scope of protection as defined by the following claims.

1. Warning device (1) associable to a dental seat, said device being adapted for warning an operator (2) of a patient's request, said device comprising
handling means (12, 14), adapted for being handled by the patient for sending a request signal;
reception means, in operating connection with said handling means, adapted for receiving said request signal;
interpreting means, in operating connection with said reception means, adapted for emitting a signal that can be interpreted by the operator.

2. Device according to claim 2, wherein said interpreting means are adapted for displaying said warning that can be interpreted by the operator to the patient before emitting it.

3. Device according to claim 1 or 2, wherein said interpreting means comprise a display (12) having at least one portion (14) that can be pointed out following the reception, by said interpretation means, of said request signal.

4. Device according to claim 3, wherein said display (12) exhibits a plurality of said portions (14), each portion being distinguishable from the other.

5. Device according to claim 4, wherein each of said portions (14) is distinguishable from the other by a different colour.

6. Device according to claim 4 or 5, wherein each of said portions (14) is distinguishable from the other by a different position on said display.

7. Device according to any one of claims from 3 to 6, wherein said portion exhibits a representation of said patient's request.

8. Device according to any one of claims from 3 to 7, wherein said portion (14) is illuminable.

9. Device according to any one of the previous claims, wherein said interpreting means comprise sound emission means adapted for emitting a sound signal based on said request signal.

10. Device according to any one of the previous claims, wherein said handling means comprise at least one switch (14) for sending said request signal.

11. Device according to claim 10, comprising a warning box (12) wherein there is provided said at least one switch (14).

12. Device according to claim 11, wherein said warning box is adapted for being gripped by the patient.

13. Device according to any one of claims from 9 to 12, wherein said at least one switch (14) exhibits a representation of the patient's request.

14. Device according to any one of the previous claims, further comprising means for controlling said interpreting means.

15. Device according to claim 14, wherein said control means comprise means for adjusting the volume (32) of said interpreting means.

16. Device according to claim 14 or 15, wherein said control means comprise language setting means (34).

17. Device according to claim 16, wherein said language setting means comprise a microprocessor.

18. Device according to claim 16 or 17, wherein said language setting means comprise a voice recording device adapted for recording the operator's voice.

19. Device according to any one of the previous claims, comprising removable protection means for covering said handling means.

20. Device according to any one of the previous claims, further comprising means for supporting the interpreting means, adapted for placing said interpreting means in a position suitable for the patient's view.

21. Dental seat associated to a warning device according to any one of the previous claims.

22. Warning kit comprising a warning device according to any one of claims from 1 to 20 and protection means adapted for covering said handling means.

23. Kit according to claim 22, wherein said protection means comprise a plurality of covers associable to said handling means and removable from them.

24. Kit according to claim 22, wherein said protection means comprise a plurality of bags adapted for containing said handling means.
